(19) United States
(12) Patent Application Publication
(10) Pub. No.: US 2018/0368389 A1
(43) Pub. Date: Dec. 27, 2018

(54) BIRD DETERRING STRUCTURE AND METHOD

(71) Applicant: RUSSELL S. ADAMS, PORT ORANGE, FL (US)

(72) Inventor: RUSSELL S. ADAMS, PORT ORANGE, FL (US)

(21) Appl. No.: 15/989,121

(22) Filed: May 24, 2018

Related U.S. Application Data
(60) Provisional application No. 62/510,486, filed on May 24, 2017.

(51) Int. Cl. A01M 29/06

(52) U.S. Cl. CPC A01M 29/06

(57) ABSTRACT

An apparatus and method for deterring birds and other animals from an area to be protected, such as, for example, a cell or communications tower. An effigy of the species to be deterred is suspended from an upper suspending structure and a lower suspending structure. The effigy may be molded or otherwise produced from rubber, plastic, or any other suitable material. The effigy may contain an internal supporting structure attached to a first cable and a second cable for suspending from the suspending structures. Either of the cables, or both, may comprise a tensioning means.

### CROSS REFERENCE TO RELATED APPLICATIONS AND INCORPORATION BY REFERENCE

This patent application is a non-provisional of U.S. provisional patent application 62/510,486 titled Bird Deterring Structure, filed in the United States Patent and Trademark Office (USPTO) on May 24, 2017, which is hereby incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

### 1. Field of the Invention

The field of the invention relates generally to devices, systems and methods for preventing animals, including fowl of various species, from alighting on structures or entering areas in which they are unwanted for any reason. In an embodiment, the invention is adapted to keep birds, for example buzzards, eagles, osprey, owls, turkey vultures, black vultures, or other vultures or birds of prey from congregating in an area where one of their own species has been injured or killed. The invention is particularly useful to protect areas or structures that are susceptible to damage from birds, such as, for example, buildings, masts, or radio towers such as cell telephone towers or beacon towers which may comprise antennas or sensitive electronics. By keeping animals such as, for example and not by way of limitation, birds, from congregating in such areas, damage from the weight of the birds, their talons, and their droppings may be prevented.

### 2. Background Art

Birds and other animals cause billions of dollars in damage, maintenance, repairs, liability, and health risks at facilities each year. An article authored by the USDA titled Dispersing Vulture Roosts on Communication Towers noted that suspending carcasses of real dead vultures proved to be a highly efficient method for controlling bird activity on or around the tested towers. Obviously, although highly effective, securing and suspending an actual dead vulture carcass from a communication tower or other structure is not a practical or long-term solution. Suspending carcasses may represent a bio-hazard, and in any even such carcasses rot and decay, and are not long lasting. Also, in order to procure such carcasses in the quantities that are commercially feasible, large number of animals would necessarily be killed in order to provide the carcasses. Such treatment of live animals may be considered to be inhumane.

What is needed in the art, therefore, is an apparatus and/or method adapted to prevent unwanted birds or other animals from entering an area that is not temporal, nor does it present a biohazard, but is able to last without significant decay for periods of years.

### BRIEF SUMMARY OF THE INVENTION

The present invention comprises an apparatus and method that have one or more of the following features and/or steps, which alone or in any combination may comprise patentable subject matter.

The present invention overcomes the shortcomings of the prior art in that it helps reduce, and, in many cases, eliminate, the hazards and damage associated, for example, with bird droppings by helping to eliminate the primary cause of these droppings—the birds themselves. It is desired to keep such unwanted birds from collecting in, on or near a subject structure. When the apparatus and method of the present invention are employed, for example, in cell and communication tower applications, the unwanted birds become agitated and confused, and quickly migrate to another property or structure that presents a less threatening sight picture. To an approaching bird, the effigy of the invention looks life-like or lifeless depending upon the effigy, often creating a confused and agitated state in the approaching unwanted bird. These agitated and confused emotions are easily transferred bird-to-bird exponentially creating confusion among an approaching flock, and thereby causing the flock to move on to another location. In this manner the effigy, and its manner of use, cause the deterring of unwanted birds from the subject structure.

The effigy of the present invention may be molded from any material such as plastic or rubber materials or compounds, or may be fabricated from any other material and by any other means in the art, and thus eliminates the inhumane treatment of animals and the potential biohazards associated with handling dead carcasses.

Use of the apparatus and method of the invention to deter birds from entering subject areas or structures is a humane approach to unwanted bird deterrence. Other methods of deterring unwanted birds or other animals, such as the use of firearms, explosives, loud noises or other means may be harmful to the birds and may present a danger to the users themselves. Subject structures such as cellular telephone or communication towers using the apparatus and method of the invention may thus safely and effectively keep unwanted birds or other animals from causing damage to such subject structures. Towers that are free of unwanted birds are not only safer to work upon and service, but the associated communications equipment suspended on or near these towers tend to have a longer in-service life as a result of being free from bird droppings and other damage cause by unwanted birds or other animals.

In accordance with one embodiment of the present invention intended to deter birds, the invention comprises an effigy of a bird that is attached to a subject structure for the purpose of making it appear as if it is a dead bird. An internal structure, disposed within the body of the effigy and to which the effigy is attached, is typically, but not necessarily, attached to a first cable and a second cable for suspending the effigy of the invention from an upper suspending structure portion and a lower suspending structure portion, which may or may not be the structure that it is intended to protect. The first cable may be attached to the upper suspending structure, and the second cable may be attached to a lower suspending structure. Either of the cables, or both, may comprise a means for tensioning the cable so that the effigy does not sway due to environmental conditions such as weather, for example wind, rain, blowing snow or ice or other environmental conditions. The effigy internal structure may be molded in place within the effigy so as to provide a supporting structure for hanging the effigy. Non-limiting examples of exemplary effigy internal structures are depicted in the figures of the drawings.

The invention also comprises a method for deterring unwanted birds or animals from a subject structure or an area. In an embodiment the method may comprise the steps of providing an effigy comprising an internal supporting structure having a distal and proximate ends and having a first cable attached to the distal end and a second cable attached to the proximate end; suspending the effigy by attaching said first cable to an upper suspending structure, and attaching said second cable to a lower suspending structure; and tensioning either of the first or second cable such that said effigy does not sway due to environmental conditions.

The effigy may represent any animal, including any animal that is desired to be deterred, and is typically, but not necessarily, an effigy of a dead animal of the species desired to be deterred.

The present method and device of the invention overcome the shortcomings of the prior art by providing, in an embodiment, a system and method for disposing a bird effigy in a position such that it appears to be dead and thus has a repelling effect on unwanted birds. In an embodiment, the effigy may be suspended from a structure in a head down orientation.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts a perspective view of the internal structure of an embodiment of the invention.

FIG. 2a depicts a perspective view of an embodiment of a bird effigy of the invention attached to cables.

FIG. 2b depicts a cut away view of an embodiment of a bird effigy of the invention attached to cables, showing the internal structure of the invention.

FIG. 3 depicts a perspective view of the curb filter of the invention after it has been inserted into a curb inlet.

FIG. 4a depicts a perspective view from the front and side of the curb filter of the invention.

FIG. 4b depicts a perspective view from the front and side of the curb filter of the invention.

FIG. 5 depicts an exemplary use of an effigy of the invention in which the effigy is suspended upside down in order to repel unwanted birds from alighting on a subject structure.

### DETAILED DESCRIPTION OF THE INVENTION

The following documentation provides a detailed description of the invention.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

As used herein, “effigy” includes within its meaning a replica of a dead bird or other animal of any species, or a live bird or other animal or any species, which may be fabricated from any material, but for example, may be fabricated from a rubber or plastic material. The effigy is preferably, but not necessarily, a three dimensional effigy having an outer surface in the three-dimensional shape of a live or dead bird or other animal.

In an embodiment, the invention comprises a bird-shaped effigy comprising an internal supporting structure for supporting the features of the effigy, such as wings, and for suspending the effigy from a supporting structure. In further embodiments, the bird-shaped effigy may further comprise an internal support structure that is attached either directly or indirectly to a supporting cable, and wherein the supporting cable is attached to the supporting structure for suspending said effigy from the supporting structure. In still further embodiments, the internal effigy support structure may comprise attachments to a first cable for attaching to an upper suspending structure and a second cable for attaching to a lower suspending structure, and may include, in either the first or second cable, a means for tensioning the cable or cables. In still further embodiments, the bird-shaped effigy is further defined as having a plurality of wings, wherein the at least one extending element is further defined as a plurality of supporting elements, one or more supporting elements for each wing of the bird-shaped effigy. The structure may be further defined as being completely contained internally in the shaped effigy. The effigy may further be defined as providing the appearance of a dead bird. The effigy may further be defined as representing in a specific species of animal or bird including, for example, a turkey buzzard, vulture, eagle, osprey, hawk or other species.

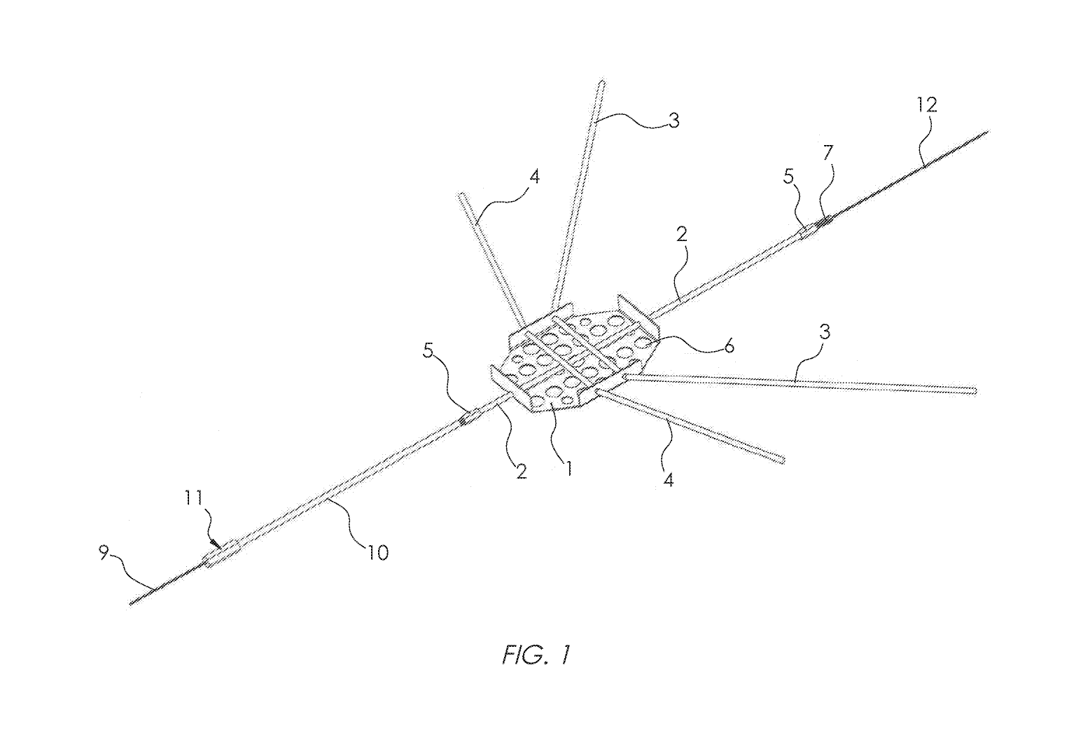

Referring now to FIG. 1, an embodiment of the internal support structure of the invention is depicted. This internal support structure may be utilized to provide structural support for the effigy as it is suspended from a structure to be protected, or “subject structure”, such as a cell or communication tower, or from a nearby structure. Internal support structure central element 1 may be attached to supporting elements 3 and 4 such that supporting elements 3 and 4 are disposed to extend away from internal support central element 1. Elongate rod 2 may extend through central element 1 forming distal and proximate ends which terminate in connectors 5 for attaching to a first cable 9 or second cable 12, or both, or, alternatively, optional extension rod 10. Connector 11 may attach cable 9 to extension rod 10. Use of optional extension rod 10 allows for the adapting of the internal support structure to various sizes and shapes of birds. First and second cables 9 and 12 may be utilized to suspend the effigy from any structure such as a tree, a communication equipment tower, building structure, or any other structure for which is desired to deter birds or other animals from approaching, nesting in, or alighting upon. For example, first cable 9 may attach to an upper suspending structure, and second cable 12 may attach to a lower suspending structure. Internal support structure central element 1 is depicted in exemplary fashion in FIG. 1 as being fabricated from sheet metal with formed, bent side walls. However FIG. 1 may be fabricated from any material, and formed in any shape that provides sufficient strength to support the supporting elements 3 and 4, and rod 2. Thus internal support structure central element 1 may be welded, cast, molded, assembled from multiple components; may be fabricated from composite materials, metal, plastics or any other material; and may take any shape as long as it provides sufficient strength to support the supporting elements 3 and 4, and rod 2. In certain alternate embodiments in which internal support structure central element 1 is fabricated from a sheet material, it may comprise at least one cutout or hole of arbitrary shape 6 in order to lighten the structure. In the exemplary embodiment depicted in FIG. 1, internal support structure central element 1 comprises a plurality of holes 6. In an embodiment, the outer surface of the effigy 100 may enclose internal support central element 1 and the supporting elements 3 and 4. Thus the internal support structure may comprise internal support structure central element 1, supporting elements 3 and 4, rod 2, and optional extension rod 10.

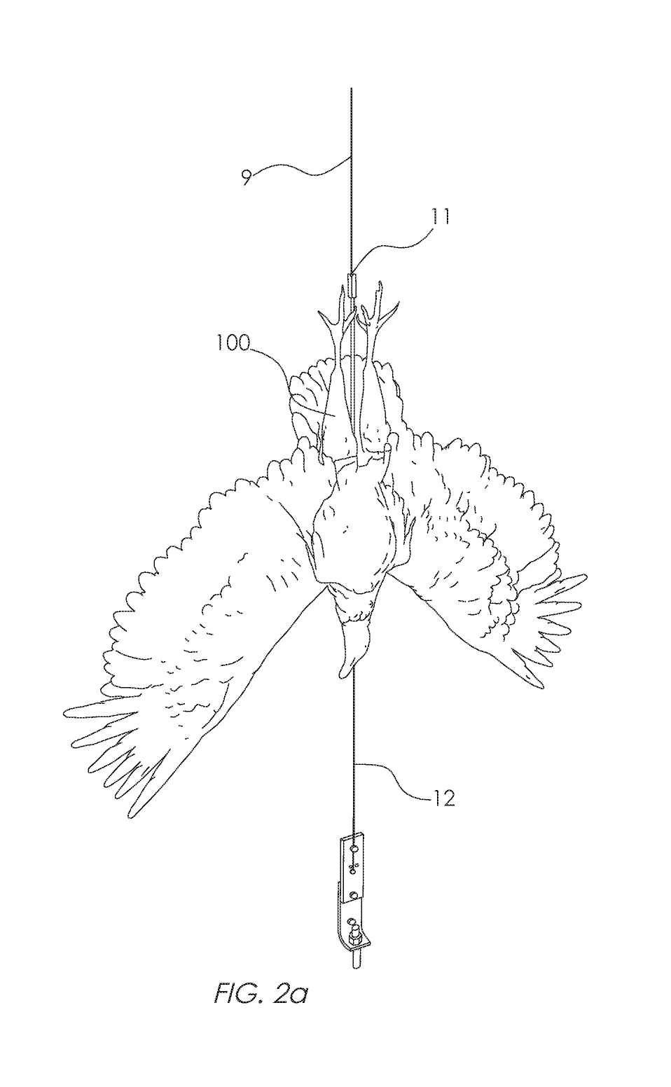

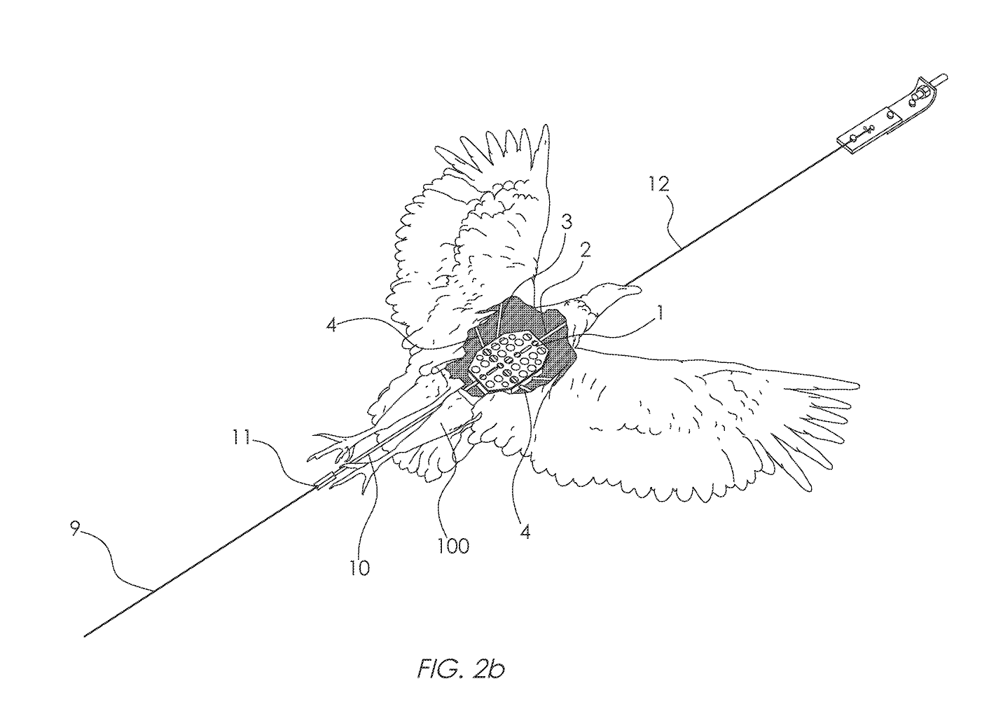

Referring now to FIG. 2a, an effigy 100 is depicted suspended from first cable 9 and second cable 12. The internal support structure is embedded within the effigy 100. In a typical application, the effigy 100 is suspended head downward, although this is not necessary. In a downward-oriented suspension, first cable 9 is attached to an upper suspending structure such as a portion of a cell or communication tower, tree or other structure. Second cable 12 is attached to a lower suspending structure and may comprise means for adjusting to provide tension in the cables in order to keep the effigy from swaying in the wind and causing damage to the structure. Connector 11 is shown for reference. In FIG. 2a, the head of effigy 100 is in the downward position.

Referring now to FIG. 2b, a cutaway view of effigy 100 is depicted, allowing the internal supporting structure to be seen. The internal support structure may be, but is not necessarily, embedded completely within the effigy 100. This may be accomplished, for example, by molding the internal support structure into the effigy 100 during the fabrication process. The “internal support structure” is defined as the structure attached to in and internal to the effigy that provides mounting points and supporting structure internal to the effigy so as to keep effigy portions such as wings or other effigy features from sagging due to the force of gravity when the effigy is suspended. In the exemplary embodiment of the invention depicted in the drawings, the internal support structure comprises internal support structure central element 1, supporting elements 3 and 4, and rod 2. An exemplary process may be described as creating a mold for the effigy 100, placing the internal support structure within the mold, and molding the effigy around the internal support structure so that only cable 12 and extension rod 10 extend outside of molded effigy 100. Extending supporting elements 3 and 4, which are attached to central element 1, may extend into a feature of the effigy 100 such as the wing area of a bird, providing support for each wing. In the example shown in FIG. 2b, it can be seen that the wings of the effigy 100 may, in some embodiments, represent a large amount of mass of the effigy 100, thus requiring internal support from extending elements 3 and 4. Some effigies, which are smaller, may not require extending support elements 3 or 4. Other effigies, which may be larger representing larger species of birds or animals, may require at least one or a plurality of extending support elements 3 and 4 to support each of the features of the effigy, such as, for example, a wing. It is to be understood that the scope of the invention includes all sizes of birds and animals, and that other types of animals may be represented by effigies having particular structural needs, thus, the scope of the invention includes any number of extending support elements 3 or 4 to support features of such effigies, and that the effigy 100 depicted in the figures of the drawing is but one example of many effigies included within the scope of the invention. Connector 11 is shown for reference. Rod 2 and first cable 9 are depicted for reference.

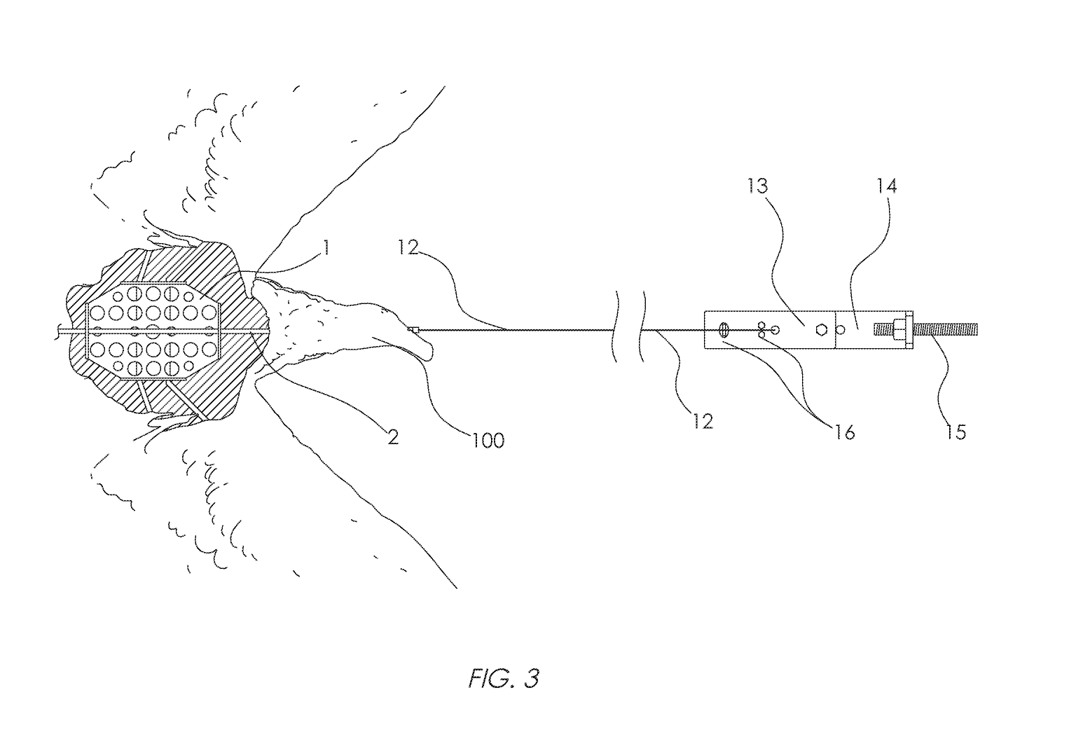

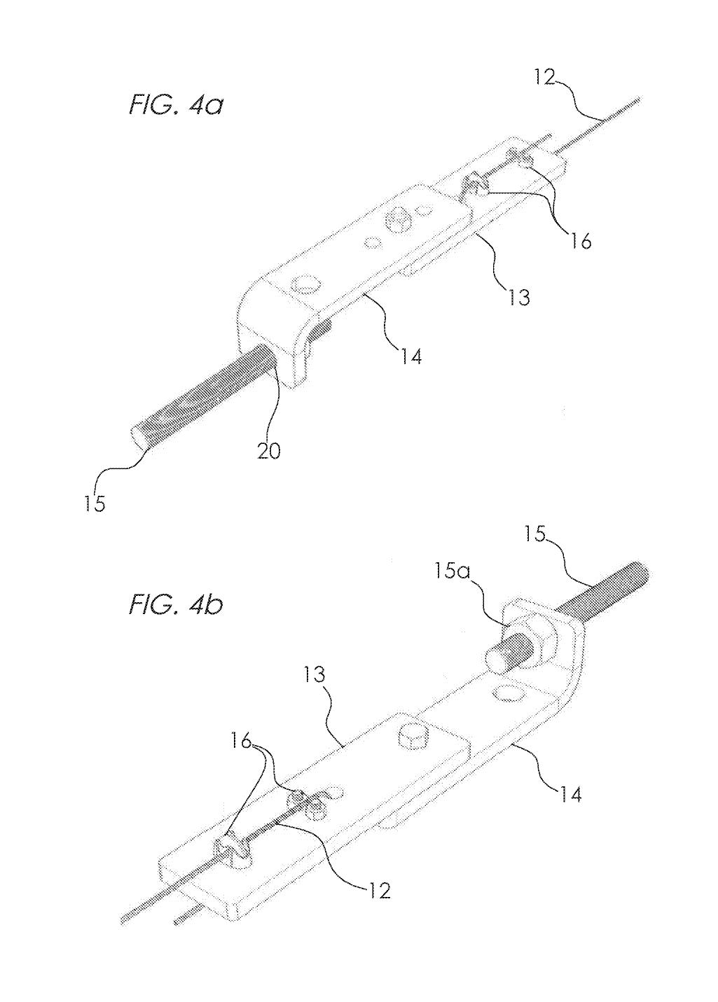

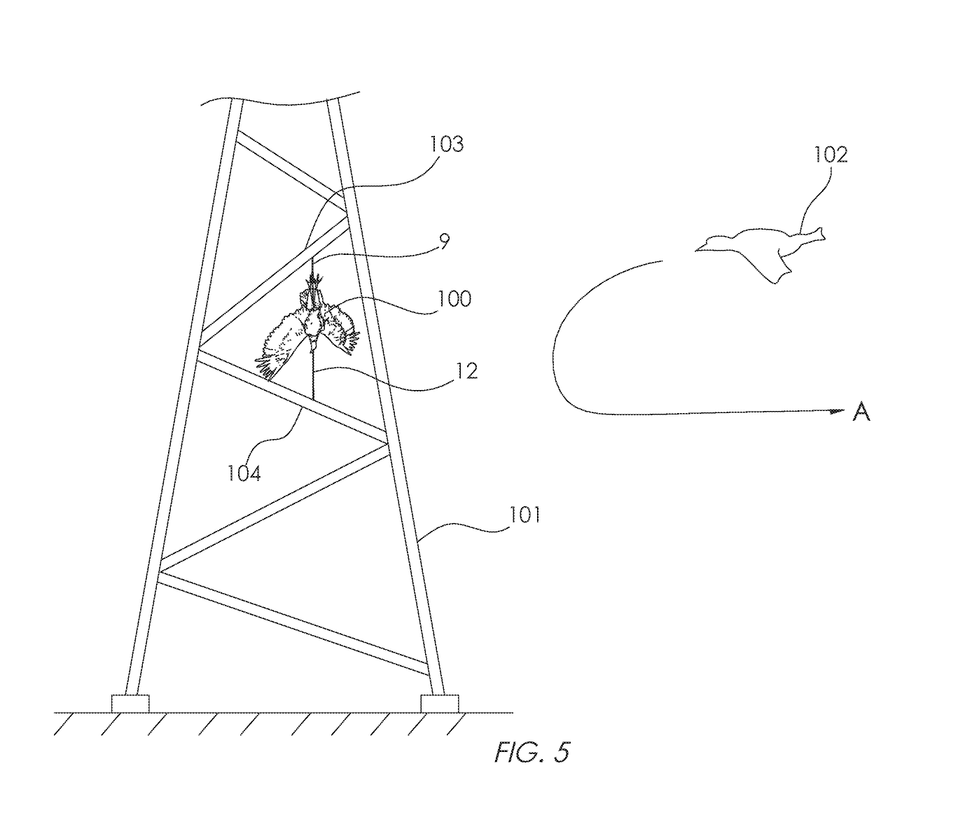

Referring now to FIG. 3, effigy 100 is depicted again in cutaway view showing the internal central structure element 1 and rod 2. Cable 12, which is connected to rod 2 extends to optional cable tightening feature comprising elements 13, 14, 15, and 16. These elements are further depicted in greater detail in FIGS. 4a and 4b. Referring now to FIGS. 4a and 4b, it can be seen that the tension in cable 12 may be adjusted by the tensioning means provided by use of at least one, and preferably a plurality of, cable clamp 16 mounted onto plate 13. Plate 13 may be bolted, welded or otherwise attached to L bracket 14 which comprises a threaded hole adapted to receive threaded rod 15 in a threaded engagement, allowing threaded rod 15 to be tightened against L bracket 14 by tightening nut 15a Using this feature of the invention, the effigy 100 may be suspended and cable 12 maybe placed into tension such that the effigy is prevented from swaying or swinging in the wind. Threaded rod 15 may be utilized to secure the apparatus to any structure. In this manner, an effigy may be suspended and cables 12 and 9 may be placed into tension, safely securing the effigy in place and preventing movement of the effigy caused by forces generated by wind, rain or other environmental forces.

Referring now to FIG. 5, an exemplary use of an effigy of the invention in which the effigy is suspended upside down from a subject structure in order to repel unwanted birds from alighting on the subject structure is depicted. Effigy 100, which may be an effigy of a dead bird such as dead vulture or turkey vulture, or any other fowl such as a turkey, is suspended from a subject structure 101. A first end of first cable 9 is attached to an upper suspending structure 103 which may be a portion of a cell or communication tower, tree or other structure 103 (depicted as a tower in FIG. 5), and a second end of first cable 9 is attached to optional extension rod 10 or rod 2 as hereinbefore described and depicted in FIG. 1. Second cable 12 may be attached on a first end to a lower suspending structure 104 and may comprise means for adjusting to provide tension in the cables in order to keep the effigy from swaying in the wind and causing damage to the structure, such as the tensioning means depicted in FIGS. 4a and 4b. In use, the effigy may cause an agitated state in approaching unwanted bird 102, causing unwanted bird 102 to fly away from the subject structure 101 as depicted by arrow A.

In an embodiment, the invention may also comprise a method for deterring birds or animals from an area, comprising the steps of: providing an effigy comprising an internal supporting structure having a distal and proximate ends; providing a first cable attached to the distal end and a second cable attached to the proximate end; suspending the effigy by attaching the first cable to an upper suspending structure, and attaching the second cable to a lower suspending structure; and tensioning said second cable such that the effigy does not sway due to environmental conditions. The method may also be further defined in that the effigy may be suspended in a head down disposition. The effigy may either be an effigy or replica of a live or dead animal, and it may be shaped in the form of a buzzard, vulture, osprey, hawk or eagle.

In still further embodiments, the effigy may be an effigy of a live bird or animal such as an eagle, osprey, hawk, or Coopers hawk. The live effigy may be presented in a heads up or other orientation, supported by a structure that rotatably attaches the bird to a supporting structure, allowing the live bird effigy rotate in such a manner that it weathervanes in the wind, meaning that it rotates due to the force of the wind on its surfaces such that it either faces into or away from the wind direction. Such effigies of live birds operate to present the appearance of a dominating territorial bird, which may repeal approaching unwanted birds. As an example, an effigy of a live bald eagle may be used to repel, or deter, an osprey from approaching a subject structure because the effigy of the live bald eagle presents a dominating presence to the osprey. Ospreys will not generally nest under a bald eagle.

Any of the effigies described herein may take the form of a vulture, turkey vulture, black vulture, buzzard, osprey, eagle, hawk, owl or Coopers hawk.

What is claimed is:

1. An apparatus for deterring birds from a subject structure, comprising a bird-shaped effigy suspended from a structure.

2. The apparatus for deterring birds of claim 1, wherein said bird-shaped effigy further comprises an internal support structure that is attached either directly or indirectly to at least one supporting cable having a first end and a second end, and wherein said at least one supporting cable is attached to said structure on said first end for suspending said effigy from said structure, and wherein said supporting cable second end is attached to said bird-shaped effigy.

3. The apparatus for deterring birds of claim 2, wherein said internal support structure is further defined as comprising an internal support structure central element attached to at least one support element for providing support to a feature of said bird-shaped effigy.

4. The apparatus for deterring birds of claim 3, wherein said internal support structure central element and said at least one support element is further defined as being completely by an outer surface of said bird-shaped effigy.

5. The apparatus of claim 1, wherein said bird-shaped effigy is further defined as having the shape of a dead bird.

6. The apparatus of claim 4, wherein said bird-shaped effigy is further defined as having the shape of a dead bird.

7. The apparatus of claim 5, in which said bird-shaped effigy is suspended in a head-down orientation.

8. The apparatus of claim 6, in which said bird-shaped effigy is suspended in a head-down orientation.

9. The apparatus claim 7, wherein said bird-shaped effigy is further defined as comprising rubber or plastic material.

10. The apparatus claim 8, wherein said bird-shaped effigy is further defined as comprising rubber or plastic material.

11. The apparatus of claim 9, wherein said bird-shaped effigy is further defined as being shaped so as to appear to be a dead vulture, turkey vulture, black vulture, buzzard, osprey, eagle, hawk or Coopers hawk.

12. The apparatus of claim 10, wherein said bird-shaped effigy is further defined as being shaped so as to appear to be a dead vulture, turkey vulture, black vulture, buzzard, osprey, eagle, hawk or Coopers hawk.

13. The apparatus of claim 11 in which either of said first cable or said second cable, or both, further comprise a tensioning means operable to adjust tension in said first and second cables.

14. The apparatus of claim 12 in which either of said first cable or said second cable, or both, further comprise a tensioning means operable to adjust tension in said first and second cables.

15. The apparatus of claim 13, in which the bird shaped effigy replicates a species of bird that is desired to be repelled.

16. The apparatus of claim 14, in which the bird shaped effigy replicates a species of bird that is desired to be repelled.

17. A method for deterring birds or animals from a structure, comprising the steps of:
providing an effigy of a dead bird or animal comprising an internal supporting structure;
suspending said effigy from a subject structure by:
providing a first cable having a first end and a second end, said first end attached to an upper supporting structure and a second said end attached to said internal supporting structure; and
providing a second cable having a first end and a second end, said second cable first end attached to a lower supporting structure and a second cable second said end attached to said internal supporting structure;
tensioning said second cable such that said effigy does not sway due to environmental conditions;
wherein said step of suspending is further defined as suspending said effigy in a position on said structure such that it is in the visual field of approaching birds.

18. The method of claim 17, wherein said effigy is suspended in a head down disposition.

19. The method of claim 17, wherein said effigy is shaped in the form of a buzzard, vulture, osprey or eagle.

20. The method of claim 18, wherein said effigy is shaped in the form of a buzzard, vulture, osprey or eagle.

21. The method of claim 17, in which the effigy replicates a species of bird that is desired to be repelled.

22. The method of claim 18, in which the effigy replicates a species of bird that is desired to be repelled.
